(19) United States
(12) Patent Application Publication
(10) Pub. No.: US 2004/0251172 A1
(43) Pub. Date: Dec. 16, 2004

(54) Apparatus and method for classifying fine particles into sub and supra micron ranges with high efficiency and throughput

(76) Inventors: Daniel Charles Coy, Naperville, IL (US); Robert John Voytas, Carol Stream, IL (US)

Correspondence Address: WILDMAN, HARROLD, ALLEN & DIXON, 225 WEST WACKER DRIVE, CHICAGO, IL, 60606, US

(21) Appl. No.: 10/849,283

(22) Filed: May 18, 2004

Related U.S. Application Data
(63) Continuation of application No. 10/047,552, filed on Jan. 14, 2002, now abandoned.

(51) Int. Cl. B07B 7/04

(52) U.S. Cl. 209/143

(57) ABSTRACT

An apparatus, including a settling chamber having a top section and a bottom section. An outlet port is positioned on the top section and an inlet port is positioned on the bottom section. The ratio of height to width of the settling chamber is greater than 0.7. A gas fluidized particle stream is introduced through the inlet port at a given velocity. A gas stream flow pattern is established within the settling chamber. Once group of particles is retarded from transportation to the outlet port and the transportation of another group of particles is facilitated to the outlet port.

### CROSS-REFERENCE TO RELATED APPLICATIONS

This application is a continuation of prior application Ser. No. 10/047,552, filed Jan. 14, 2002.

### FIELD OF THE INVENTION

The invention involves the separation of nanoparticles in general and, in particular an improved nanoparticle settling chamber and method for separating and classifying nanoparticles.

### BACKGROUND OF THE INVENTION

The preparation of fine particulate materials, e.g., “nanoparticles”, or “ultrafine”, or “fume” particles having a size range of less than about one micron, more typically less than one half a micron, has been the subject of numerous academic and industrial studies. These nanoparticles may exist either freely, or as clusters of up to a few microns in size. Great interest exists in both the characterization and manufacture of these substances in view of their known and as yet undiscovered applications and utility. Of particular importance is the production of nanoparticles having a relatively monodisperse particle size distribution wherein the size range is less than about one micron. The unique and often unrealized aspects of making, sorting and collecting such small particles on a large scale has resulted in an ongoing need to develop new and useful devices, methods and processes to perform these tasks.

The collection and separation of particles of varying sizes has been the subject of many technical papers. The state-of-the-art of separating many kinds of particles is well summarized in Perry's Chemical Engineers' Handbook, 7^{th} ed.. Section 17, Gas-Solid Separations, and Section 25, Air-Pollution Management of Stationary Sources. The teaching of these publications are hereby incorporated by reference.

Numerous patents have also addressed the state of the art of apparatuses that are used for the separation of particles of varying sizes. For example, one such patent, U.S. Pat. No. 5,348,163 issued to Tunison et al. discloses a separation apparatus that utilizes an impingement plate to distribute a high velocity particle flow. A drawback of this device is that newly formed nanoparticle clusters or tacky particles hit the impingement plate and stick together, thus, forming larger particles, or ‘snowballs’ that can not be separated. Consequently, these snowballs cause a decline in the efficiency of the gas flow pattern within the chamber as well a decrease in the ability to separate particles.

Methods which are typically used to conduct separation of particles in size ranges down to the micron-size include, but are not limited to, settling chambers utilizing various impingers, centrifugal separators, cyclone separators, and impingement separators. A drawback of each of the devices is that they do not efficiently separate fume from dust when the fume is tacky (i.e., bound together by electrostatic forces).

Various solutions to the problem of producing high-quality nanopowders without the presence of microparticles are known, however. These include certain processes such as forming fume from the combustion of high-purity liquid precursors that are capable of producing microparticle-free nanopowders. A shortcoming of such processes, however, is that they also produce hard agglomerates of nanoparticles that are less desirable in many applications than condensed individual nanoparticles.

A second solution is applicable in cases where the nanoparticles are not tacky. In such cases, turbine classifiers or high-efficiency cyclones may be expected to provide efficient particle size separation. A problem associated with this solution, however, is that it is extremely difficult to achieve electrostatic neutrality (i.e., non-tacky or non-condensing dry surfaces) on particles in the size range of interest without otherwise affecting the particles.

Given these problems, an improved nanoparticle product, apparatus and method for classifying nanoparticles in a fluidized-gas stream that overcomes these shortcoming would be an important advancement in the art.

### OBJECTS OF THE INVENTION

An object of the invention is to provide an improved nanoparticle product and an improved settling chamber and method for classifying nanoparticles that overcome some of the problems and shortcomings of the prior art.

Another object of the invention is to provide an improved nanoparticle product and an improved settling chamber and method for classifying nanoparticles that allows a nanoparticle/microparticle stream to be fed to a separator at a controlled velocity.

Still another object of the invention is to provide an improved nanoparticle product and an improved settling chamber and method for classifying nanoparticles that allows for the development of a flow pattern that does not allow large particles to be carried from the inlet to the outlet in local high velocity streams or eddies. How these and other objects are accomplished will become apparent from the following descriptions and from the drawings.

### SUMMARY OF THE INVENTION

The invention involves a settling chamber for separating nanoparticles from microparticles with an aspect ratio of the height to the width of sufficient value to allow two circulation zones to be formed, one above the other. The invention also includes a method for substantially separating fine particles from contaminant and coarse agglomerated particles into two size ranges, the first size range being greater than about 10 microns and the second size range being no greater than 10 microns, the method is comprised of the steps of: (a) introducing a gas-fluidized fine particle stream into a particle classifier vessel, the vessel having an inlet port and an outlet port located above the inlet port; (b) circulating the gas-fluidized fine particle stream inside the classifier vessel in such a manner as to define flow patterns within the vessel which provide for physico-chemical conditions whereby particles having a size greater than about 10 microns are separated from smaller particles; (c) substantially separating the particles in the gas stream that are larger than about 10 microns from the particles in the gas stream that are no greater than about 10 microns; and (d) passing the particles no greater than about 10 microns through the outlet port.

One particular embodiment of the inventive method involves the steps of: (a) providing a settling chamber including a bottom section having a first diameter, a frustoconical top section with an outlet port located therein, and an inlet port having a second diameter located in a side of the bottom section where the ratio of the first diameter to the second diameter is approximately 4 to 1; (b) introducing a gas-fluidized particle stream through the inlet port into the settling chamber at a given velocity; (c) establishing a gas stream flow pattern within the settling chamber that retards the transport of microparticles to the outlet port while facilitating the transport of nanoparticles to the outlet port; and (4) collecting the nanoparticles from the outlet port.

### BRIEF DESCRIPTION OF THE DRAWINGS

FIG. 1 shows an upright box separator that is well known in the art.

FIG. 2 shows a conventional settling chamber that utilizes an axial entrance that allows a high-velocity fluidized gas stream to impinge on a horizontal baffle plate in order to produce uniform upward flow.

FIG. 3 shows an inventive settling chamber for separating nanoparticles from microparticles.

### DETAILED DESCRIPTIONS OF THE INVENTION

The present invention provides advances in the production, classification and collection of nanoparticles in a fluidized gas via an inventive settling chamber or separator that allows for classifying nanoparticles. Alternatively, the present invention can be used whenever the reduction of nanoparticles, or fume content in a gas stream of larger so called “dust” particles (that is particles larger than about 10 microns) is desired.

In order to better understand the invention it is helpful to review some of the settling chambers and methods for separating nanoparticles that are currently in use.

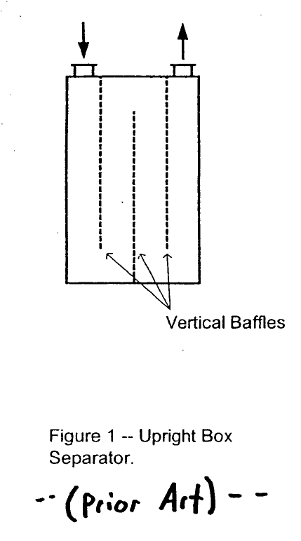

FIG. 1 shows an upright box separator that is well known in the art. This type of a separator employs vertical baffles within the separator vessel. When in use, a fluidized gas stream is introduced into the vessel through an opening in the top of the vessel. Once inside the vessel larger particles are deposited as inertial forces carry them out of the flow stream and to the floor of the separator as the flow direction changes from downward to upward. Once deposited, the large particles remain on the floor of the separator since the velocity at the wall is not sufficient to re-entrain them. In practice, this device was found to allow 47 ppm of particles exceeding 43 microns to pass through. Oversized particle loading entering the separator exceeded 1000 ppm.

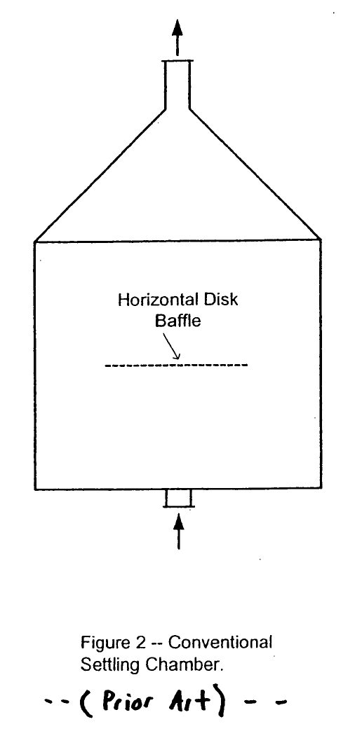

FIG. 2 shows a conventional settling chamber that utilizes an axial entrance that allows a high-velocity fluidized gas stream to impinge on a horizontal baffle plate in order to produce uniform upward flow. The performance associated with this type of settling chamber is poor in that as the nanoparticle fume travels up an inlet pipe toward the chamber, a significant portion of the fume condenses on the interior of the pipe wall. As the thickness of the coating on the wall increases, so does the velocity of the gas through the pipe due to the decreasing cross-sectional area. Eventually, however, the system reaches equilibrium where the rate of nanoparticle condensation equals the rate at which bulk section of condensed nanoparticles slough off on to the pipe wall.

The rate of material that sloughed off on to the pipe wall can be a significant faction of the total rate of nanoparticle flow through the system. This can result in much of the material that is sloughed off on to the pipe wall becoming too large to be carried through the separator thereby greatly reducing the yield of the separator. Additionally, the condensed nanoparticle material on the wall of the pipe may also contain embedded microparticles exceeding 43 micrometers (i.e., 325 mesh) in size. Although these microparticles are too large and dense to be carried through the separator on their own, they are easily carried through when their apparent density is reduced by a low-density covering of nanoparticles. Surprisingly, the efficiency of this low rise-velocity settling chamber was poorer than the simple box separator. In practice, this device was found to allow 94 ppm of particles exceeding 43 microns to pass through. Oversized particle loading entering the separator exceeded 1000 ppm.

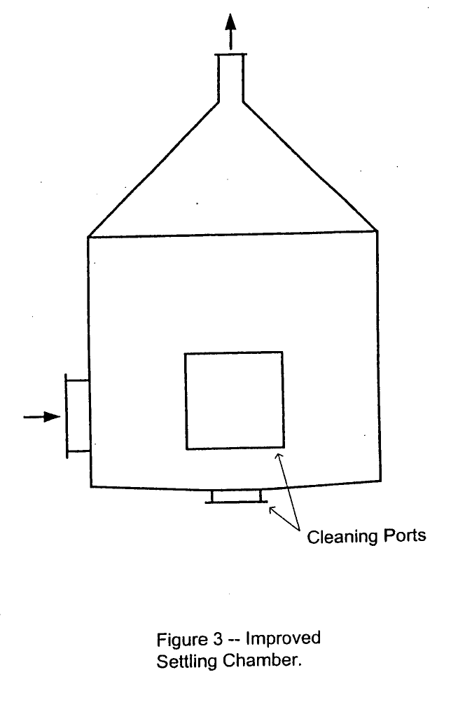

In contrast, FIG. 3 shows an inventive settling chamber for separating nanoparticles from microparticles. The settling chamber has an aspect ratio of the height to the width of sufficient value to allow two circulation zones to be formed, one above the other. In accordance with one example of the present invention, the settling chamber is comprised of a bottom section and a frustoconical top section, an outlet port located in the top section, an inlet port located in a side of the bottom section and a cleaning port located in the bottom section. The bottom section has a first diameter of 48 inches, the inlet port has a second diameter and the ratio of the first diameter to the second diameter is approximately 4 to 1. Surprisingly, the efficiency of the inventive device exceeded theoretical performance for a settling chamber of this size. In practice, this device was found to allow <1 ppm of particles exceeding 43 microns to pass through. Oversized particle loading entering the separator exceeded 1000 ppm. Further wet sieve testing at 20 microns and 10 microns also found particle levels below the detection limit for the method.

In another embodiment of the invention, the frustoconical shape of the top section is approximately that of a 90° cone and the outlet port is located in the top of the cone. Although the inlet port location can be varied, a location approximately 6 inches above the floor of the vessel allows the desired flow pattern and for the collection of a large amount of settled material before vessel cleaning is necessary.

In still another embodiment of the invention, the chamber has a particular height and the ratio of the second diameter to the height of the chamber is approximately 1 to 3.5. In this same embodiment, the outlet port may have a third diameter and the ratio of the third diameter to the second diameter is approximately 1 to 3.

As shown in FIG. 3, the bottom and top sections of the settling chamber are constructed about a substantially vertical axis. The inlet port is constructed about a substantially horizontal axis and the axis of the inlet port is substantially perpendicular to the axis of the bottom and top sections.

Various materials including, but not limited to, stainless steel can be used in the construction of the chamber. The inlet and outlet ports may also be constructed of various materials without departing from the spirit of the invention. Theses ports may be connected to the chamber in any of the ways known in the art including, for example, welding.

Unlike the standard settling chambers currently in use, the inlet port on the chamber that is the subject of this invention is designed to prevent the formation of condensed nanoparticles that result in undesired yield loss and the transport of entrained microparticles. This results in chamber performance that greatly exceeds that of any standard settling chambers currently in use.

Additionally, unlike the prior art, the inventive settling chamber does not utilize any impingers located within the chamber. This eliminates particle buildup or “snowballing” in the chamber and results in a more efficient flow pattern within the chamber as well.

The invention also involves a method for substantially separating fine particles from contaminant and coarse agglomerated particles into two size ranges, the first size range being greater than about 10 microns and the second size range being no greater than 10 microns. The inventive method is comprised of the steps of: (a) introducing a gas-fluidized fine particle stream into a particle classifier vessel, the vessel having an inlet port and an outlet port located above the inlet port; (b) circulating the gas-fluidized fine particle stream inside the classifier vessel in such a manner as to define flow patterns within the vessel which provide for physico-chemical conditions whereby particles having a size greater than about 10 microns are separated from smaller particles; (c) substantially separating the particles in the gas stream that are larger than about 10 microns from the particles in the gas stream that are no greater than about 10 microns; and (d) passing the particles no greater than about 10 microns through the outlet port.

In a specific embodiment of the inventive method, the method is comprised of the steps of: (a) providing a settling chamber including a bottom section having a first diameter of 48 inches, a frustoconical top section with an outlet port located therein, and an inlet port having a second diameter located in a side of the bottom section where the ratio of the first diameter to the second diameter is 4 to 1; (b) introducing a gas fluidized particle stream through the inlet port into the settling chamber at a given velocity; (c) establishing a gas stream flow pattern within the settling chamber that retards the transport of microparticles to the outlet port while facilitating the transport of nanoparticles to the outlet port; and (d) collecting the nanoparticles from the outlet port.

In this embodiment of the invention, the gas stream flow pattern is introduced into the settling chamber at a volumetric flow rate of 100-200 scfm, however, flow of no less than 10 scfm and no greater than 1000 scfm can be used without departing from the spirit of the invention.

The flow pattern is further comprised of a main recirculating flow pattern in the bottom section of the chamber and a secondary recirculating flow pattern in the top section of the chamber that is sympathetic to the main flow pattern. This embodiment further includes the step of creating an interface between the main recirculating flow pattern and the secondary recirculating flow pattern.

The advantage of a dual recirculating flow pattern is that it prevents the transport of microparticles by local high velocity eddies. This results in chamber performance that exceeds that which is predicted for standard settling chambers currently in use.

The nanoparticles separated in the invention can be any one of several materials including but not limited to, for example metal oxides, metal nanoparticles, metal carbides, mixed metal oxides or metal nitrides. These nanoparticles may exist either freely, or as clusters of up to a few microns in size.

While the principles of the invention have been shown and described in connection with but a few embodiments, it is understood clearly that such embodiments are by way of example and are not limiting.

1. An apparatus, comprising:
a settling chamber having a top section and bottom section;
an outlet port positioned on the top section; and
an inlet port positioned on the bottom section; wherein a ratio of height to width of the settling chamber is greater than 0.7.

2. The apparatus of claim 1, wherein the ratio of height to width of the settling chamber is greater than 1.2.

3. The apparatus of claim 1, wherein the bottom section comprises:
a base;
an inlet port connected to the sidewall; and
the ratio of the size of the base to the size of the inlet port is approximately 4 to 1.

4. The apparatus of claim 3, wherein the inlet port is located approximately one half the inlet port size (diameter) higher than the base.

5. The apparatus of claim 3, wherein the base is circular.

6. The apparatus of claim 3, wherein the sidewall is cylindrical.

7. The apparatus of claim 1, wherein the inlet port is generally circular and a central axis of the inlet port is perpendicular to a central axis of the sidewall.

8. The apparatus of claim 6, wherein the inlet port is generally circular and a ratio of a diameter of the sidewall to a diameter of the inlet port is 4 to 1.

9. The apparatus of claim 1, wherein the inlet port is generally circular and a ratio of the height of the settling chamber to a diameter of the inlet port is greater than 2.8.

10. The apparatus of claim 9, wherein the ratio of the height of the settling chamber to the diameter of the inlet port is greater than 4.8.

11. The apparatus of claim 1, wherein the inlet port and the outlet port are generally circular and a ratio of the diameter of the inlet port to a diameter of the outlet port is 3 to 1.

12. The apparatus of claim 1, wherein the top section has a frustoconical shape.

13. The apparatus of claim 12, wherein the top section has a cone angle of 90 degrees.

14. The apparatus of claim 12, wherein the outlet port is located at a top portion of the frustoconical shape.

15. The apparatus of claim 1, wherein the apparatus is constructed of stainless steel.

16. The apparatus of claim 1, wherein the inlet port is welded to the settling chamber.

17. A method of using a settling chamber, comprising:
providing the settling chamber with a top section and a bottom section, an outlet port positioned on the top section, and an inlet port positioned on the bottom section, wherein a ratio of height to width of the settling chamber is greater than 0.7;
introducing a gas fluidized particle stream through the inlet port at a given volume flow rate;
establishing a gas stream flow pattern within the settling chamber that retards transportation of one group of particles to the outlet port and facilitates transportation of another group of particles to the outlet port; and
collecting the other size of particles at the outlet port.

18. The method of claim 17, wherein the one group of particles has particles less than 10 microns and the other group of particles has particles greater than 10 microns.

19. The method of claim 17, wherein the step of establishing comprises:
establishing a main recirculating flow pattern in the bottom section; and
establishing a secondary recirculating flow pattern in the top section.

20. The method of claim 19, further comprising creating an interface between the main recirculating flow pattern and the secondary recirculating flow pattern.

21. The method of claim 17, wherein the step of establishing comprises:
establishing a main recirculating flow pattern in the bottom section; and
establishing a secondary, sympathetic recirculation flow pattern in the top section;
wherein the axes of rotation of both recirculating flow patterns are primarily horizontal and substantially perpendicular to the inlet stream.

22. The method of claim 17, wherein the step of introducing comprises radial introduction of the gas fluidized particle stream into the settling chamber.

23. The method of claim 17, wherein the step of introducing comprises introducing the gas fluidized particle stream at a given volume flow rate of 10-1000 scfm.

24. The method of claim 23, wherein the step of introducing comprises introducing the gas fluidized particle stream at a given volume flow rate of 100-200 scfm.

25. The method of claim 17, wherein the step of introducing comprises introducing a gas fluidized particle stream comprising one of metal oxide nanoparticles, metal nanopowders, metal nitride, mixed metal oxides, metal carbides and metal sulfide nanoparticles.

26. The method of claim 17, wherein the step of introducing comprises introducing a gas fluidized particle stream comprising particles having a minimum particle size of approximately 0.001 micron.

27. The method of claim 17, wherein the step of introducing comprises introducing a gas fluidized particle stream comprising free particles.

28. The method of claim 17, wherein the step of introducing comprises introducing a gas fluidized particle stream comprising particle clusters.

29. The method of claim 17, wherein the step of introducing comprises introducing a gas fluidized particle stream comprising free particles and particle clusters.

30. The method of claim 17, further comprising selecting the bottom section to be cylindrical.

31. The method of claim 30, further comprising selecting a diameter of the bottom section to be 48 inches.

32. The method of claim 31, wherein the step of introducing comprises introducing a gas fluidized particle stream at a volume flow rate of at least 10 scfm.

33. The method of claim 31, wherein the step of introducing comprises introducing a gas fluidized particle stream at a volume flow rate no greater than 1000 scfm.

34. A system, comprising:
means for introducing a gas fluidized particle stream into a settling chamber; and
means for establishing a gas stream flow pattern within the settling chamber that retards transportation of one group of particles to an outlet port and facilitates transportation of another group of particles to the outlet port.

35. The system of claim 34, wherein the one group of particles consists of particles having a size less than 10 microns and the other group of particles consists of particles having a size greater than 10 microns.

36. The system of claim 34, wherein the means for establishing comprises:
means for establishing a main recirculating flow pattern; and
means for establishing a secondary recirculating flow pattern.

37. The system of claim 36, further comprising means for creating an interface between the main recirculating flow pattern and the secondary recirculating flow pattern.

38. The system of claim 34, further comprising:
a means for establishing a main recirculating flow pattern; and
a means for establishing a secondary, sympathetic recirculation flow pattern, where the axes of rotation of both recirculating flow patterns are primarily horizontal and substantially perpendicular to the inlet stream.

39. The system of claim 34, further comprising radial introduction of the gas fluidized particle stream into the settling chamber.

40. The system of claim 34, wherein the means for introducing comprises means for introducing the gas fluidized particle stream at a given volume flow rate of 10-1000 scfm.

41. The system of claim 40, wherein the means for introducing comprises means for introducing the gas fluidized particle stream at a given volume flow rate of 100-200 scfm.

42. The system of claim 34, wherein the means for introducing comprises means for introducing a gas fluidized particle stream comprising one of metal oxide nanoparticles, metal nanopowders, metal nitride, mixed metal oxides, metal carbides and metal sulfide nanoparticles.

43. The system of claim 34, wherein the means for introducing comprises means for introducing a gas fluidized particle stream comprising particles having a minimum particle size of approximately 0.001 micron.

44. The system of claim 34, wherein the means for introducing comprises means for introducing a gas fluidized particle stream comprising free particles.

45. The system of claim 34, wherein the means for introducing comprises means for introducing a gas fluidized particle stream comprising particle clusters.

46. The system of claim 34, wherein the means for introducing comprises introducing a gas fluidized particle stream comprising free particles and particle clusters.
